(19) United States
(12) Patent Application Publication
(10) Pub. No.: US 2006/0278805 A1
(43) Pub. Date: Dec. 14, 2006

(54) DEVICE AND METHOD FOR SUSPENSION OF A VEHICLE SEAT BY MEANS OF ADDITIONAL VOLUMES

(76) Inventor: Erwin Haller, Bergland (DE)

Correspondence Address: BLACK LOWE & GRAHAM, PLLC, 701 FIFTH AVENUE, SUITE 4800, SEATTLE, WA, 98104, US

(21) Appl. No.: 11/382,686

(22) Filed: May 10, 2006

(30) Foreign Application Priority Data
May 13, 2005 (DE) 10 2005 023 088.1

(51) Int. Cl. F16M 13/00

(52) U.S. Cl. 248/588; 248/550; 248/421; 267/136

(57) ABSTRACT

The invention relates to a device and a method for suspension of a vehicle seat by means of additional volumes, in particular a utility vehicle seat, comprising at least one air spring (8) for height adjustment of a seat part (2), said air spring being arranged between the seat part (2) and a lower part (6), and a control device for controlling the supply and discharge of at least one additional volume to or from the air spring (8), wherein, at predefinable speed or acceleration values of a spring movement of the air spring (8), the additional volume which can be supplied or discharged can be switched on or off by means of the control device in such a way that, in end-of-travel regions of the air spring (8), the profile of a force/travel air spring characteristic (44-46; 50-54; 58, 61-66) during an extension and/or return spring movement of the air spring (8) does not exhibit any incline in a first and in a second range (37, 38; 40, 48; 55, 56).

### DESCRIPTION

The invention relates to a device and a method for suspension of a vehicle seat by means of additional volumes, in particular a utility vehicle seat, comprising at least one air spring for height adjustment of a seat part, said air spring being arranged between the seat part and a lower part, and a control device for controlling the supply and discharge of at least one additional volume to or from the air spring, according to the preambles of claims 1 and 9.

Suspension devices for vehicle seats are known in particular for damping a height excursion of the vehicle seat when travelling over uneven road surfaces, such as potholes. EP 1 188 608 A1 discloses an active damping system for sprung vehicle seats, in which, in addition to a mechanical flexible connection device, a pneumatic off-load device and a hydraulic actuator are arranged between a seat part and a lower part which. is connected to the vehicle. Both the pneumatic off-load device and the hydraulic actuator are controlled by a control device as a function of a seat error signal, which is generated for example by a jerky height adjustment of the seat part.

Such hydraulic actuators require a connection to the on-board power supply of the vehicle, in particular a utility vehicle, such as a tractor. Such a connection means that the action of the active damping of the vehicle seat is dependent on the function of the on-board power supply and in particular the parameters thereof, so that the parameters of the damping system have to be matched to the parameters of the on-board power supply and thus the system has to be adapted to the respective utility vehicle. Moreover, such suspension devices are of simple design in so far as the hydraulic actuator, upon receipt of a position error signal in relation to the vehicle seat, which is subjected to the weight of a driver, is supplied with air by means of a compressor and as a result an increased air volume is created for sufficient damping of the vehicle seat. Along their height adjustment, such suspension devices do not have any comfort region which extends over a relatively long section of the height adjustment travel and thus represents uniform suspension within this height adjustment range with the same return forces.

Also known are air springs which have a linear force/travel air spring characteristic, the incline in which differs as a function of the configuration of the air spring and an applied additional volume. In such air springs, use is usually made of additional volumes which are kept constant and which are associated with the extending and retracting air spring as the actual air volume of the air spring.

Such air volumes which are kept constant mean that, when the air spring is set with a force/travel air spring characteristic having a small incline, it is not possible for the seat part to swing back into a central position of the force/travel air spring characteristic since friction forces within the suspension device as a whole are greater than a return force within the force/travel air spring characteristic.

On the other hand, if the suspension device is designed such that the return force is greater—that is to say a greater incline of the air spring characteristic is set—a relatively hard damping is achieved both in the central travel region and in the end-of-travel regions of the air spring.

Moreover, when using an air spring in an air spring characteristic range with a small incline (the so-called comfort range), which requires the switch-on of a large additional volume, it is probable that the end stops in end-of-travel regions of the air spring will be reached in the event of considerable extension and retraction movements due to considerable unevenness, as a result of which a reduced seating comfort is obtained for the user of the vehicle seat. In the case of air springs for vehicle seats, the setting of a comfort range is usually desired on account of better transmission values and the resulting higher level of comfort.

Such a comfort range of the air spring characteristic has to date been set by the manufacturer such that it can be used universally for different roads and ground with different levels of unevenness. Since tractors in particular, which travel both on tarred roads and on dirt tracks or even on fields, have very different requirements in terms of optimizing the suspension device or a suspension system for the tractor vehicle seat, a universal comfort range that has been set from the start can be only a compromise for effective suspension of the vehicle seat on different types of ground.

Accordingly, the object of the present invention is to provide a suspension device for a vehicle seat which permits increased driving comfort for a user during use of the vehicle seat in a comfort range, which is represented by a force/travel air spring characteristic with very small incline or no incline at all, and in end-of-travel regions which lie outside the comfort range. The object of the invention is also to provide a method for suspension of the vehicle seat by means of such a suspension device.

This object is achieved in respect of the device by the features of claim 1 and in respect of the method by the features of claim 9.

The core concept of the invention is to provide a suspension device for a vehicle seat, in particular a utility vehicle seat, comprising at least one air spring for height adjustment of a seat part, said air spring being arranged between the seat part and a lower part, and a control device for controlling the supply and discharge of at least one additional volume to or from the air spring, which, at predefinable speed or acceleration values of a spring movement of the air spring, allows the additional volume which can be supplied or discharged to be switched on or off by means of the control device in such a way that, in end-of-travel regions of the air spring, the profile of a force/travel air spring characteristic during an extension and/or return spring movement of the air spring does not exhibit any incline or exhibits only a small incline in a first and in a second range. In this way, depending on the speed with which the air spring extends due to the uneven ground on which the utility vehicle, such as a tractor for example, is moving, a type of ground detection is carried out which, by means of the control device functioning as software, calls up a predefinable procedure for the supply and discharge of the additional volume which is provided for the respective type of ground. Particularly when the air spring is moved at medium, high and very high speeds, that is to say when the spring travel of the air spring changes at medium, high and very high speeds, and possibly with measured values being added to the amplitude values of the spring travel, the additional volume is switched on in the end-of-travel regions or is maintained in comparison to the comfort range, in such a way that the air spring does not experience any change in force either during extension or during its return or during both movements, as shown in the characteristic curve of the force/travel diagram.

By way of example, at a first, medium speed or acceleration value, the vibration-damping additional volume which can be supplied and discharged in the first and second range during the extension spring movement is in each case smaller than in a third range (the comfort range) which lies between the first and second range, or is fully switched off, so that as a result a rise in pressure is obtained in the end-of-travel regions during the extension of the air spring, which leads to a shortening of the spring travel. During the return spring movement, the additional volume is then partially or fully switched on, so that as a result a horizontally running section is obtained within the force/travel air spring characteristic. This leads to a return of the air spring with an additional volume having a value from a range of for example 0.1-10 1, and to reduced vibration.

From a second speed or acceleration value, which corresponds to a considerable introduction of force and thus lies above the first value, the additional volume within the first and second range is switched on both during the extension spring movement and during the return spring movement, resulting in a type of neutral position of the suspension system as a whole. There is therefore no rise in pressure in the first and second ranges, which represent the end-of-travel regions and lie outside the comfort range, regardless of whether the air spring is subjected to pressure or tensile stress, that is to say whether the vehicle seat is moved downwards or upwards. The air spring thus extends and returns in this first and second range without any opposing force. Vibration is reduced.

At a third speed or acceleration value, which corresponds to a very considerable introduction of force and lies above the two previous values, the additional volume in the first and second range for the extension movement is in each case greater than in the third range, or is fully switched on, and during the return spring movement is fully switched off or is supplied to a lesser extent than in the third range. There is therefore no rise in pressure in the first and second ranges during the extension movement of the spring, for which reason the air spring extends and returns without any opposing force. At the point of reversal of the movement direction, that is to say during the return spring movement, an increase in energy or a progression takes place as the vehicle seat moves upwards and a reduction in energy or a depression takes place as the vehicle seat moves downwards. In both cases, vibration is very considerably reduced as a result. A high level of damping thus takes place.

According to one preferred embodiment, the third range within the force/travel air spring characteristic, as the comfort range of the suspension device, is designed to have a variable width depending on further speed or acceleration values, which lie below the first, second and third speed or acceleration values, and optionally depending on predefinable amplitude values of the spring movement. As a result, on account of the measured speed or acceleration values and optionally the detected excursion distances or amplitude values, which make it possible to determine the type of ground on which the vehicle, for example a tractor, is currently travelling, a mode assigned to these values is called up within the control device, said mode defining the boundaries of the comfort range. By way of example, when travelling on a tarred road, low speed values and excursion distances and measured, whereupon the “road” mode is activated, said mode not providing for any comfort range since a sufficiently precise central seat position is ensured without any large excursion distances. Other modes are “road transition”, at which a transition from the tarred road to a dirt track or vice versa takes place and thus a narrower comfort range is defined, and the “difficult ground/field, etc.” mode, in which a wide comfort range is set on account of the introduction of considerable forces, which mean relatively large excursion distances and relatively high speed values.

According to one preferred embodiment, the suspension device has at least one pneumatic directional control valve for supplying or discharging the additional volume(s).

One further development of the invention comprises an adjustment device for automatic height adjustment of the seat part at the start of a use operation by a user having a predefined weight by means of air being supplied to or discharged from the air spring in such a way that the air spring adjusts to a central position in the third range of the force/travel air spring characteristic. The adjustment device comprises a regulator switch which is arranged in the region of the armrest of the vehicle seat.

The third range, that is to say the comfort range, can be displaced within the force/travel air spring characteristic by means of an operating device by the user and by means of the control device in such a way that the seat part is adjusted to the desired height with sufficiently vibration-damping first and second ranges.

In addition, a recognition device may be provided for recognizing a user using the vehicle seat, in particular by means of his weight.

Further advantageous embodiments emerge from the dependent claims.

Advantages and expedient features can be found in the following description in conjunction with the drawing, in which:

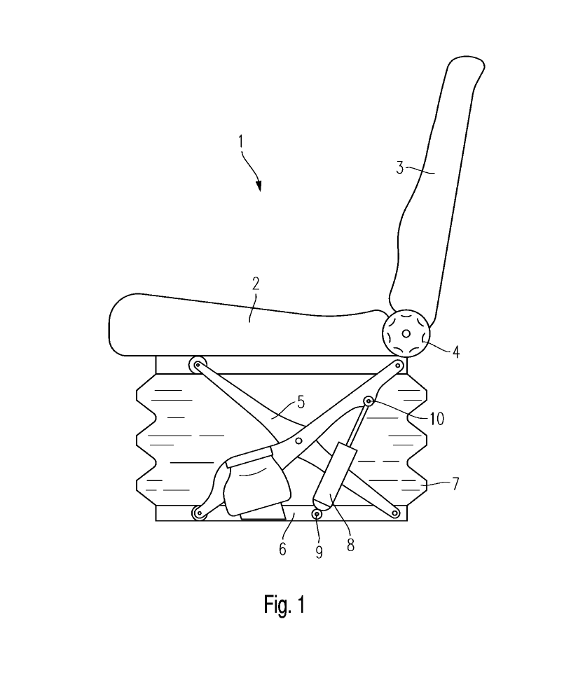

FIG. 1 shows a schematic side view of a vehicle seat comprising an air spring;

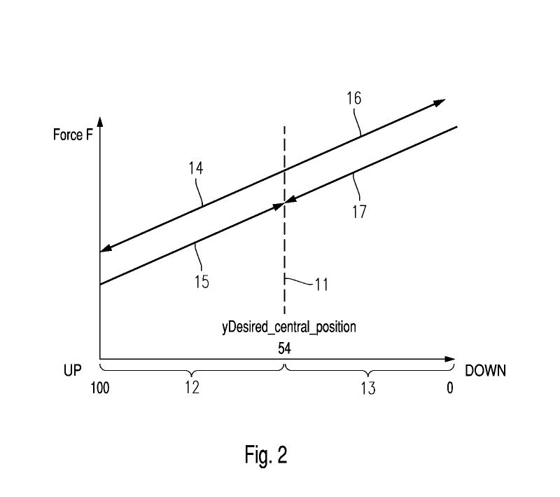

FIG. 2 shows a schematic diagram of a force/travel air spring characteristic of a suspension device in the “road” mode according to one embodiment of the invention;

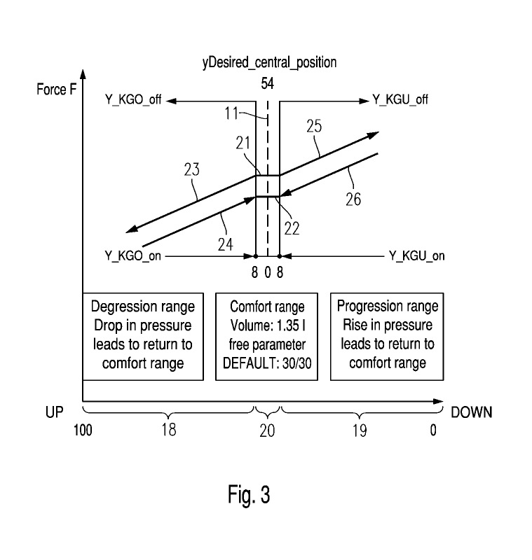

FIG. 3 shows a schematic diagram of the force/travel air spring characteristic of the suspension device in the “road transition” mode;

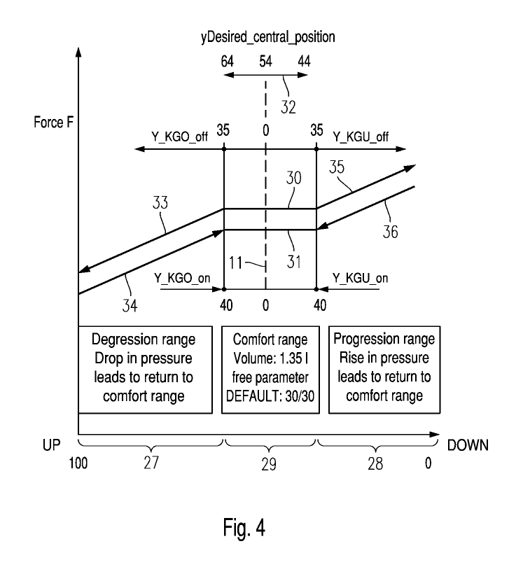

FIG. 4 shows a schematic diagram of the force/travel air spring characteristic of the suspension device in the “difficult ground/field, etc.” mode;

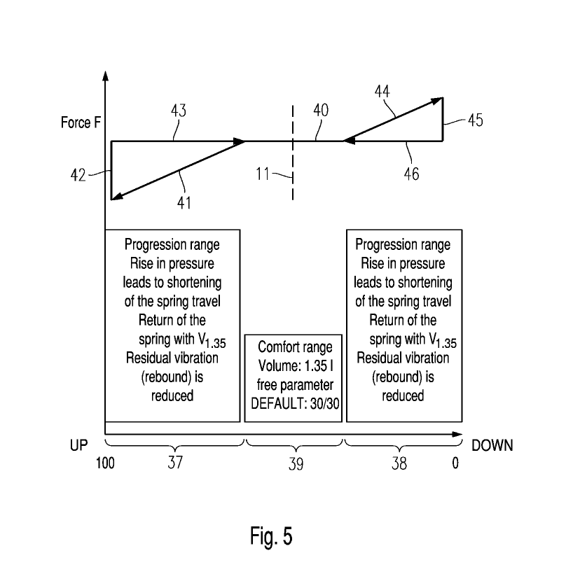

FIG. 5 shows a schematic diagram of the force/travel air spring characteristic of the suspension device at medium spring excursion speeds;

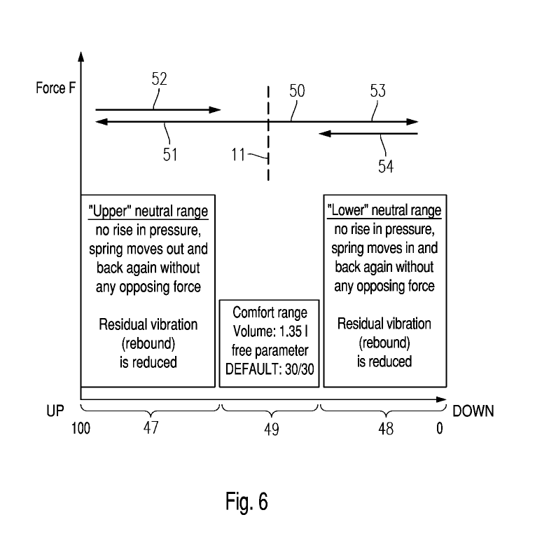

FIG. 6 shows a schematic diagram of the force/travel air spring characteristic of the suspension device at high spring excursion speeds;

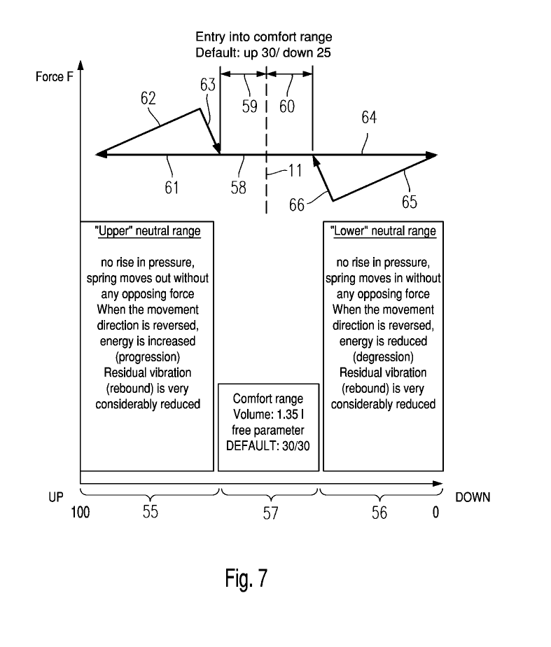

FIG. 7 shows a schematic diagram of the force/travel air spring characteristic of the suspension device at very high spring excursion speeds.

FIG. 1 shows a schematic side view of a vehicle seat. The vehicle seat 1 consists of the seat part 2 and the back rest 3, which are connected to one another by means of a pivot bearing 4. An x-shaped height-adjustable connecting frame 5 is arranged on a lower part 6 within a bellows-like covering part 7, said lower part being connected to the vehicle for example by means of guide rails.

An air spring 8 is arranged between an upper part of the frame and the lower part 6. The air spring 8 is connected by its lower end 9 to the lower part 6 and by its upper end 10 to the upper part of the frame. The air spring can be subjected to pressure and tensile stress.

Both the x-shaped frame and the air spring are height-adjustable in such a way that they move downwards when subjected to pressure by a driver using the vehicle seat or when travelling over a pothole and move upwards and/or vibrate for example after travelling over a pothole.

FIG. 2 shows a diagram of the force/travel air spring characteristic of the suspension device according to the invention in the “road” mode. The abscissa shows a height adjustment travel over 100 mm. The desired central position 11 of the vehicle seat in respect of its height is shown in the centre of the measurement range of 100 mm.

The upward movement of the air spring and thus of the seat part 2 is shown in a first range 12 of the air spring characteristic, and the downward movement of the air spring and thus of the seat part 2 is shown in a second region 13. The lighter arrows represent an extension spring movement and the darker arrows represent a return spring movement.

At a measured spring excursion speed value of less than 0.114 m/s, the control device automatically switches into the “road” mode, in which an air spring characteristic with the usual incline and without a comfort range is achieved both during the extension spring movement and during the return spring movement. A comfort range is not required here due to the stable central position of the seat, which is possible on account of the low level of unevenness of a tarred road.

When the seat part and thus the air spring move upwards, a force reduction is obtained, as shown by the arrow 14. During the return movement, the force increases so as to allow a return to the central position, as shown by the arrow 15.

When the seat part and the air spring move downwards, there is an increase in force as shown by the arrow 16, which disappears again due to a reduction in force during the return spring movement as shown by the arrow 17.

FIG. 3 shows a diagram of the force/travel air spring characteristic of the suspension device for the “road transition” mode. In this case, there is a transition of the utility vehicle from the tarred road to an uneven road, such as a dirt track, or vice versa.

In a first range 18 and a second range 19, the air spring movements and the return thereof are shown by means of the arrows 23, 24 and 25, 26. TN addition, a third range 20 comprising the characteristic sections 21, 22 is arranged as a narrow comfort range in the region of the central position 11, which is obtained by supplying an additional volume of for example 1.35 1.

In the first range 18, which represents a degression range, there is a drop in pressure during the movement (reference 23), which leads to a return to the comfort range 20. In the second range 19, which represents a progression range, a rise in pressure during the movement 25 leads to a return 26 to the comfort range 20.

FIG. 4 shows a diagram of the force/travel air spring characteristic of a suspension device in the “difficult ground/field, etc.” mode. Once again, the excursion and return spring movements 33, 34 and 35, 36 shown in a first and a second range 27, 28 run along the customary incline in the air spring characteristic. p In a third range 29, a wide comfort range comprising the characteristic sections 30, 31 is shown, said comfort range being designed to be relatively wide on account of the uneven ground being travelled over, so as to achieve maximum comfort. This mode is activated at spring excursion speeds of more than 0.114 and less than 0.228 m/s. Reference 32 schematically shows the section of the height adjustment travel in which the vehicle seat can rise and fall with a high level of comfort within the comfort range 29.

In the first range 27, which represents a degression range, a drop in pressure leads to a return to the comfort range, whereas, in the second range 28, which represents a progression range, a rise in pressure leads to a return to the comfort range.

Automatic detection of or distinction between the road conditions according to the modes as illustrated in FIGS. 2 to 4 can be effected as follows:

At the start, a weight adjustment takes place when the vehicle seat is newly occupied by a new driver. This takes place automatically, wherein the suspension device is set to an optimized central position level determined beforehand during a previous use of the vehicle. If the vehicle seat is briefly left, for example for a period of less than 8 seconds, no break in occupancy of the seat is detected. No readjustment thus takes place. Longer breaks, as required for example when connecting a trailer, do not lead to readjustment provided that the weight of the vehicle driver does not change when the seat is reoccupied.

In addition, initial height adjustment of the vehicle seat is possible when there are no large spring excursion movements.

Once the weight has been set and the height has been adjusted, the suspension device is automatically set to the “road transition” mode at the start of travel. Depending on the condition of the road and the forces introduced as a result into the suspension device and/or the spring excursions, the “road” or “difficult ground/field, etc.” mode is selected by means of the control device following the evaluation of spring excursion speed or acceleration values. If no values relating to the “difficult ground/field, etc.” mode exist, the “road” mode is selected by way of priority. This permits level-optimized seating in relation to the optimized operation of brake pedals, clutch pedals, etc.

When changing from the “difficult ground/field, etc.” mode to the “road” mode, this takes place via the “road transition” mode within a period of approx. 10 seconds. Upon leaving the tarred road, adjustment parameters of the suspension device are immediately set to the “difficult ground/field, etc.” mode on account of the detected values for the spring excursion and the speeds of the spring excursion.

FIG. 5 shows a diagram of the force/travel air spring characteristic of the suspension device at medium spring excursion speeds. The width of a third range 39, which represents the comfort range, corresponds to the width of the comfort range shown in FIG. 4. This can also be seen on the basis of a characteristic section 40.

In a first range 37, in the event of an upward spring movement as shown by reference 41, the additional volume is firstly switched off, as a result of which a rise in pressure is obtained in the progression range shown here, which leads to a shortening of the spring travel. During a return spring movement during the transition from the arrow 41 to an arrow 42, 43, the additional volume is then switched on, which, after the previous braking during the spring excursion movement 41, gives rise to an increase in force as shown by reference 42, up to the level of the horizontally running characteristic section 40. The air spring is then returned to the comfort range by means of the additional volume without any incline in the characteristic (cf. reference 43).

In a second range 38, during a downward spring movement, braking is effected by initially switching off the additional volume (reference 44). The additional volume is then switched on at the transition to the return spring movement 45, 46, wherein an initial reduction in force is achieved down to the level of the horizontally running characteristic section 40 and then the return characteristic continues without any incline, as shown by reference 46. Vibration is reduced in both cases.

FIG. 6 shows a diagram of the force/travel air spring characteristic of the suspension device at a high spring excursion speed of for example more than 0.3185 m/s and less than 0.353 m/s. In the event of an upward or downward spring movement in this speed range, in a first and second range 47, 48 of the air spring characteristic the additional volume is already switched on at the start of the spring movement, that is to say when passing beyond the boundaries of a comfort range 49. As a result, a characteristic 51, 52 and 53, 54 which runs horizontally and without any incline in continuation of a characteristic section 50 is obtained during the extension and return spring movement.

In such a first and second range which is neutral with respect to the characteristic profile, no rise in pressure takes place during the spring movement and the suspension moves out or in and back again without any opposing force. Vibration is further reduced.

FIG. 7 shows a diagram of the force/travel air spring characteristic of the suspension device at a spring excursion speed of more than 0.353 m/s. As in the diagram shown in FIG. 6, in a first range 55 and in a second range 56 the additional volume is once again already switched on at a transition out of the third range or the comfort range 57. As a result, a continuation of the characteristic 58, which already runs horizontally in the comfort range, is once again obtained, as shown by characteristic sections 61, 64.

At the point of reversal from the extension spring movement to the return spring movement, that is to say in the region of the tips of the two arrows 61, 64, the additional volume is switched off, resulting in an increase in force or a reduction in force while at the same time covering a section as shown by references 62, 65. A considerable reduction in force or a considerable increase in force then takes place as shown by references 63, 66. Accordingly, no rise in pressure takes place during the spring movement, as a result of which the air spring moves out in the first range 55 and moves in in the second range without any opposing force. From the point of reversal of the movement direction of the air spring, an increase in energy (progression) takes place in the first range and a reduction in energy (degression) takes place in the second range. Vibration is very considerably reduced in both cases, resulting in a high level of damping.

All of the features disclosed in the application documents are claimed as essential to the invention in so far as they are novel individually or in combination with respect to the prior art.

### List of References

1 vehicle seat
2 seat part
3 back rest
4 pivot bearing
5 x-shaped frame
6 lower part
7 bellows-like covering
8 air spring
9 lower end of the air spring
10 upper end of the air spring
11 desired central position
12,18,27,37,47,55 first range of the air spring characteristic
13,19,28,38,48,56 second range of the air spring characteristic
14,23,33,41,51,61 upward extension spring movement
15,24,34,42,43,52,62,63 return spring movement associated with the upward extension spring movement
16,25,35,44,53,64 downward extension spring movement
17,26,36,45,46,54,65,66 return spring movement associated with the downward extension spring movement
20,29,39,49,57 third range of the air spring characteristic
21,22,30,31,40,50,58 characteristic section in the third range
32 spring movement in the comfort range

1-12. (canceled)

13. A suspension device for a vehicle seat comprising:
at least one air spring for height adjustment of a seat part of the vehicle seat, said air spring arranged between the seat part and a base section of the vehicle seat; and
a control device for controlling at least one additional volume of air to and from the air spring,
wherein at one or more predefined values of movement of the air spring the at least one additional volume of air is activated by the control device when the air spring is positioned at one of a first or a second end-of-travel configuration and a force applied by the at least one air spring is substantially constant during a movement of the at least one air spring.

14. The suspension device of claim 13, wherein at a first predefined value of movement of the air spring the at least one additional volume of air is deactivated when an extension movement of the at least one air spring occurs activated when a return movement of the at least one air spring occurs.

15. The suspension device of claim 13, wherein at a second predefined value of movement of the air spring the at least one additional volume of air is activated when an extension movement and a return movement of the at least one air spring occur.

16. The suspension device of claim 13, wherein at a third predefined value of movement of the air spring the at least one additional volume of air is activated when an extension movement of the at least one air spring occurs and deactivated when a return movement of the at least one air spring occurs.

17. The suspension device of claim 13, wherein an amount of travel of the at least one air spring varies when a measured value of a movement of the air spring is less than at least one predefined amplitude value of the movement of the air spring.

18. The suspension device of claim 13, further comprising:
an adjustment device for automatically adjusting a height of the seat part according to a predefined weight of a user wherein air is exchanged to or from the air spring to adjust the air spring to a central position.

19. The suspension device of claim 18, wherein the adjustment device comprises a regulator switch located in an armrest of the vehicle seat.

20. The suspension device of claim 13, further comprising:
an operating device to alter the force in the at least one air spring.

21. A method for suspension of a vehicle seat having at least one air spring controllable by a control device for height adjustment of a seat part, the at least one air spring arranged between the seat part and a base section of the vehicle seat, the method comprising:
controlling at least one additional volume of air to and from the at least one air spring with the control device in correspondence with one or more predefined values of movement of the air spring; and
exchanging the at least one additional volume of air with the air spring by activating the control device when the air spring is operating in one of a first or a second end-of-travel regions and when a force applied by the at least one air spring is substantially constant during a movement of the at least one air spring.

22. The method of claim 21, wherein controlling comprises deactivating the at least one additional volume of air when a first predefined value of movement of the air spring occurs.

23. The method of claim 21, wherein controlling comprises activating the at least one additional volume of air when a second predefined value of movement of the air spring occurs.

24. The method of claim 21, wherein controlling comprises activating the at least one additional volume of air when a first predefined value of movement of the air spring occurs during an extension or a compression of the air spring and deactivating the at least one additional volume of air when the first predefined value of movement of the air spring occurs during a return of the air spring to a neutral state.
